(19) United States
(12) Patent Application Publication
(10) Pub. No.: US 2008/0279650 A1
(43) Pub. Date: Nov. 13, 2008

(54) Device for Fastening an Attachment to a Support Page

(75) Inventor: Ingo Hauser, Kandern (DE)

Correspondence Address: BAKER & DANIELS LLP;111 E. WAYNE STREET, SUITE 800, FORT WAYNE, IN, 46802, US

(73) Assignee: A. RAYMOND ET CIE, Grenoble (FR)

(21) Appl. No.: 12/097,939

(22) PCT Filed: Dec. 1, 2006
(86) PCT No.: PCT/EP2006/011572

§ 371 Date: Jul. 28, 2008

(30) Foreign Application Priority Data
Dec. 24, 2005 (DE) 10 2005 062 242.9

(51) Int. Cl. F16B 19/10

(52) U.S. Cl. 411/45

(57) ABSTRACT

A device for fastening an attachment (4) to a support part (18) is provided with a bearing part (1) that can be connected to the attachment (4) via connecting means (2); with a rivet pin (8) seated in a rivet aperture (7) of the bearing part (1) displaceably between a preassembly position and a final assembly position and comprising laterally projecting latching projections (15) and a pin receiving shaft (12), said latching projections (15) being operative in the final assembly position to engage behind the support part (18); and with a lock pin (13) seated in the pin receiving shaft (12) displaceably between a released position and a locked position, said lock pin (13) being operative in the locked position to block radial movement of the latching projections (15). The attachment (4) can thus be connected to the support part (18) in such a way that it is preoriented relative to the support part (18) in the final assembly position of the rivet pin (8), before final connection is effected by pushing the lock pin (13) into the locked position.

### CROSS-REFERENCE TO RELATED APPLICATION

This application is a U.S. National Phase Patent Application based on International Application Serial No. PCT/EP2006/011572 filed Dec. 1, 2006, the disclosure of which is hereby explicitly incorporated by reference herein.

### BACKGROUND OF THE INVENTION

1. Field of the Invention

The present invention relates to a device for fastening an attachment to a support part.

2. Description of the Related Art

One known device for fastening an attachment to a support part is disclosed by FR 2 075 179 A. The previously known device has a bearing part that can be connected to the attachment via a connector with a rivet pin seated in a rivet aperture of the bearing part displaceably between a preassembly position and a final assembled position and comprising laterally projecting latching projections and a pin receiving shaft, said latching projections being operative in the final assembly position to engage behind the support part; and with a lock pin seated in the pin receiving shaft displaceably between a released position and a locked position. The lock pin in the locked position blocks radial movement of the latching projections that are molded onto the free ends of elongated spring pins joined at the back in the direction of insertion. For this reason, the lock pin has to be inserted almost to the end of the pin receiving shaft for secure locking.

DE 31 14 283 A1 discloses a device for fastening an attachment to a support part that has a rivet body that can be joined to a support part that is made with a receiving shaft extending lengthwise of the rivet body. A pin is mounted displaceably in the receiving shaft that can be brought into engagement with an attachment that is to be connected to the support part by means of the aforementioned device. After the pin is inserted into the rivet body, projections on the pin grip behind the rivet body so that the attachment is fastened to the support part in a final assembled position.

### SUMMARY OF THE INVENTION

The present invention provides a device for secure locking of the latching projections with a very small insertion path for the locking pin.

The latching projections are then located on the front by the configuration pursuant to the invention, so that the locking pin assumes its locking position even after a very small insertion path.

In one form thereof, the present invention provides a device for fastening an attachment to a support part with a bearing part that can be connected to the attachment through a connector, with a latching projection projecting laterally mounted in a rivet recess of the bearing part displaceably between a preassembly position and a final assembled position, and a rivet pin that has a pin receiving shaft, wherein the latching projections in the final assembled position grip behind the support part, and with a locking pin mounted in the pin receiving shaft displaceably between a release position and a locking position, wherein the locking pin in the locking position blocks radial motion of the latching projections, characterized by the fact that the latching projections are made on spring tab sections, because of encircling clearances on three sides of an area on the front of the locking pin in the direction of insertion of the locking pin, in an area on the back, and that the locking pin in the locking position extends so far into the pin receiving shaft that its forward end in the direction of insertion is located at the level of the free ends of the tab sections, and blocks motion of the tab sections relative to one another.

### BRIEF DESCRIPTION OF THE DRAWINGS

The above mentioned and other features and objects of this invention, and the manner of attaining them, will become more apparent and the invention itself will be better understood by reference to the following description of embodiments of the invention taken in conjunction with the accompanying drawings, wherein:

FIG. 1 in a side view, an example of embodiment of a device pursuant to the invention that is connected to an attachment;

FIG. 2 in cross section, the example of embodiment of FIG. 1, with a bearing part in a preassembly position and a locking pin in a release position; and

FIG. 3 the example of embodiment of FIG. 1 and FIG. 2 in engagement with an attachment and a support part, wherein the bearing part is in a final assembled position and the locking pin is in a locking position.

Corresponding reference characters indicate corresponding parts throughout the several views. Although the exemplifications set out herein illustrate embodiments of the invention, in several forms, the embodiments disclosed below are not intended to be exhaustive or to be construed as limiting the scope of the invention to the precise forms disclosed.

### DETAILED DESCRIPTION

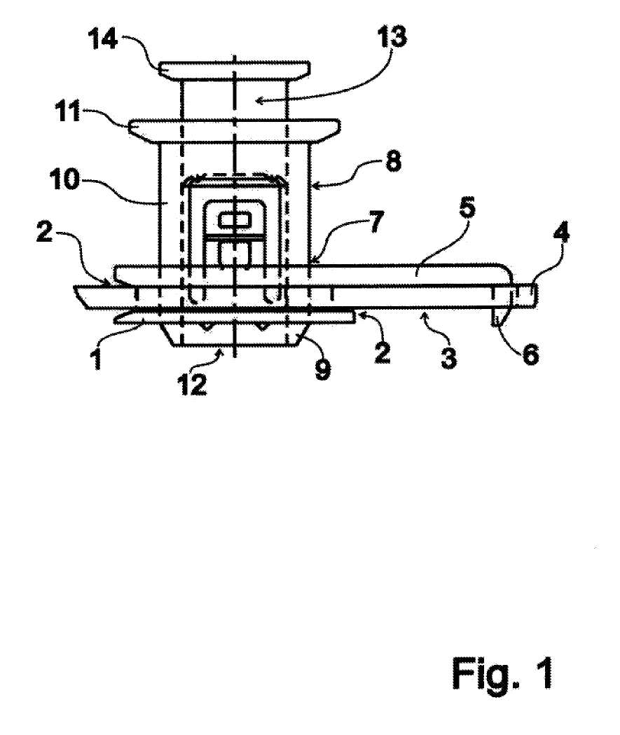

FIG. 1 shows in a side view an example of embodiment of the device pursuant to the invention that has a bearing part 1. In the illustration according to FIG. 1, the bearing part 1 with grooves 2 is located as a connector in a narrow end area of a bearing recess 3 in an attachment 4 of somewhat droplet shape. The connector molded to the bearing part 1 also has a projecting latching spring arm 5, at the free end of which is configured an angled stop lug 6 disposed confronting an edge side of bearing aperture 3 in a region of broader circumference configured for the insertion of the inventive device, such that after stop lug 6 has been snapped into bearing aperture 3, bearing part 1 is fixed.

Bearing part 1 is provided with a rivet aperture 7 which is oriented transversely to latching arm 5, and in which a rivet pin 8 is disposed in a preassembly position in the representation according to FIG. 1. In the preassembly position, the rivet pin 8 extends beyond bearing part 1 by a beveled centering head 9, while a shank portion 10 of rivet pin 8 protrudes from bearing part 1 on the opposite side from centering head 9. Shank portion 10 terminates, at its end facing away from centering head 9, in a radially projecting supporting edge 11. Rivet pin 8 is configured with a centrally disposed pin receiving shaft 12 that is open at both ends, and in which a lock pin 13, shown in a release position in the representation according to FIG. 1, is seated displaceably in the longitudinal direction. Lock pin 13 also has a radially projecting supporting edge 14 at its end facing away from rivet pin 8.

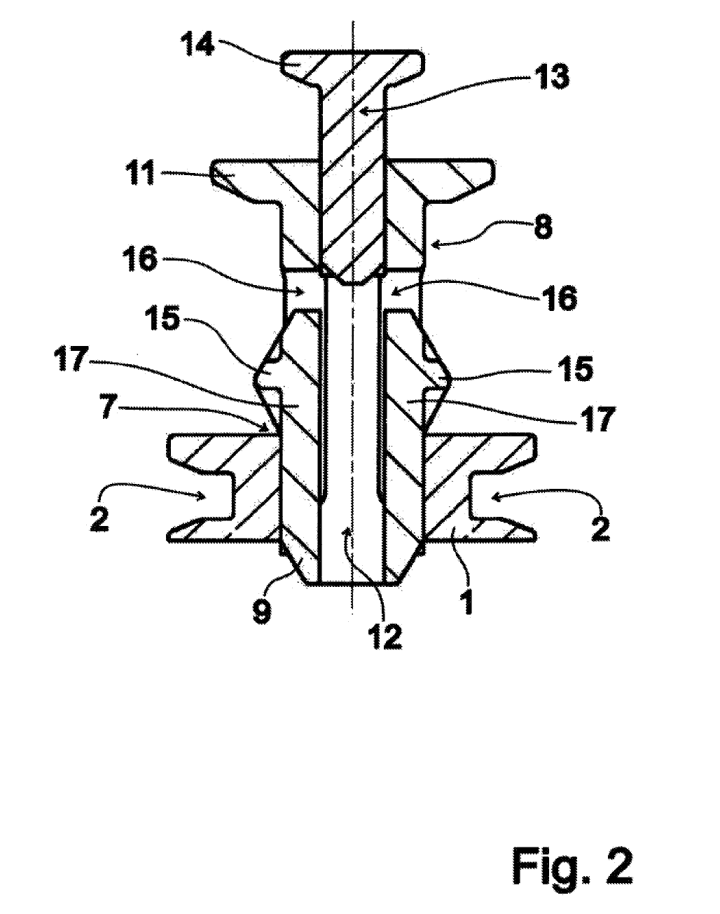

FIG. 2 shows the exemplary embodiment according to FIG. 1 in section, looking at the side facing away from lock arm 5, which is not visible in FIG. 2. It can be seen from FIG. 2 that rivet pin 8 is provided with laterally extending latching projections 15, which in the preassembly position of rivet pin 8 shown in FIGS. 1 and 2 rest against the edge of the rivet aperture 7 of bearing part 8. The latching projections 15 are configured on resilient tongue sections 17, by virtue of circumferential clearances 16 that are present on three sides, such that when rivet pin 8 is shifted from the preassembly position depicted in FIGS. 1 and 2 to a final assembly position in which the supporting edge 11 of rivet pin 8 rests against bearing part 1, latching projections 15 pass through rivet aperture 7 and, after traversing rivet aperture 7, emerge resiliently at the other end.

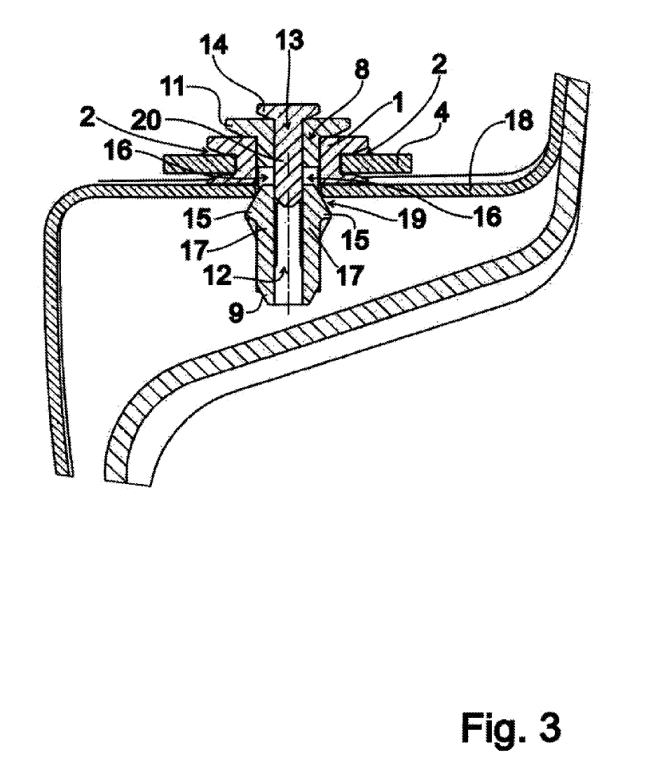

FIG. 3 shows the exemplary embodiment according to FIGS. 1 and 2 in engagement with a support part 18 to which attachment 4 is to be fastened. In the arrangement according to FIG. 3, rivet pin 8 is in the final assembly position, in which its supporting edge 11 rests against bearing part 1 and the latching projections 15 engage behind an edge of a receiving aperture 19 provided in support part 18. In addition, in the representation according to FIG. 3, lock pin 13 is in a locked position in which its supporting edge 14 rests against the supporting edge 11 of rivet pin 8, and the free end of a shank portion 20 extending away from supporting edge 14 reaches so far into pin receiving shaft 12 that movement of tongue portions 17 toward each other is blocked.

The attachment 4 is thereby fixedly connected to the support part 18, after, in a multi-step assembly operation proceeding from the arrangement according to FIG. 1, the attachment 4 is initially fixable in a preoriented arrangement by engaging centering head 9 in receiving aperture 19 and shifting rivet pin 8 from the preassembly position to the final assembly position, and, after adoption of the final arrangement, the final, operationally reliable connection between the attachment 4 and the support part 18 is made secure by shifting the lock pin 13 from the released position according to FIGS. 1 and 2 to the locked position according to FIG. 3.

To release the connection between attachment 4 and support part 18, lock pin 8 can be shifted, for example by suitable manipulation at its supporting edge 14, from the locked position according to FIG. 3 back to the released position according to FIGS. 1 and 2, so that rivet pin 8 can then also be shifted from the final assembly position according to FIG. 3 back to the preassembly position according to FIGS. 1 and 2, with the passage of latching projections 15 through receiving aperture 19 and pin receiving shaft 12.

Corresponding reference characters indicate corresponding parts throughout the several views. Although the exemplifications set out herein illustrate embodiments of the invention, in several forms, the embodiments disclosed below are not intended to be exhaustive or to be construed as limiting the scope of the invention to the precise forms disclosed.

1-4. (canceled)

5. A device for fastening an attachment to a support part with a bearing part connectable to the attachment through a connector, said device comprising:
a rivet pin mounted in a rivet recess of the bearing part and displaceable between a preassembly position and a final assembled position, said rivet pin including a pin receiving shaft and a plurality of laterally-projecting latching projections, said latching projections disposed on respective spring tab sections of said rivet pin that include free ends, and said latching projections in said final assembled position engaging behind the support part; and
a locking pin received in said pin receiving shaft and movable between a release position and a locking position, said locking pin blocking radial movement of said latching projections in said locking position; and
said rivet pin further including encircling clearances on at least three sides thereof in an area behind said latching projections and in front of said locking pin in a direction of insertion of said locking pin, said locking pin in said locking position extending into said pin receiving shaft to an extent such that a forward end thereof is located at a level of said free ends of said tab sections and blocks motion of said tab sections relative to one another.

6. The device of claim 5, wherein said rivet pin and said locking pin include respective radially extending blocking edges, said blocking edge of said rivet pin in said final assembled position resting on the bearing part and said blocking edge of said locking pin in said locking position resting on said rivet pin.

7. The device of claim 5, wherein said rivet pin includes a beveled centering head that, in said preassembly position of said rivet pin, projects beyond the bearing part.

8. The device of claim 5, wherein the connector is molded to the bearing part.
